(19) United States
(12) Patent Application Publication
(10) Pub. No.: US 2011/0000511 A1
(43) Pub. Date: Jan. 6, 2011

(54) DEEP CLEAN CYCLE

(75) Inventors: Matthew D. Mersch, Louisville, KY (US); Timothy Wetzel, Louisville, KY (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/496,247

(22) Filed: Jul. 1, 2009

(51) Int. Cl. B08B 3/00

(52) U.S. Cl. 134/26; 134/56 D

(57) ABSTRACT

A dishwasher includes a housing, a wash chamber in the housing that receives kitchenware therein, a detergent dispenser for introducing a detergent into the wash chamber, and a heater for raising temperature in the wash chamber. The dishwasher further includes a controller for selectively controlling water supply to and from the dish chamber. The controller establishes a temperature of the wash fluid circulating in the wash chamber during the first period in a range from about 115° F. (46° C.) to about 135° F. (58° C.) to enhance the wash performance of enzyme-based detergents and establishes a temperature of the wash fluid during a second period in the range from about 150° F. (65° C.) to about 160° F. (72° C.) to enhance wash performance of a chlorine-based detergent. A method of washing kitchenware contained in the dishwasher comprises (i) removing loose soil on the kitchenware in at least one pre-wash cycle, (ii) washing the kitchenware in a main wash cycle, and (iii) rinsing the kitchenware in at least one rinse cycle. The main wash cycle comprises the actions of (i) washing the kitchenware in a first temperature range for enzyme-based detergent for a first period and (ii) washing the kitchenware in a second temperature range for chlorine-based detergent for a second period.

### BACKGROUND OF THE DISCLOSURE

The present disclosure relates to a dishwasher and more specifically to a dishwasher that runs a deep clean cycle or routine.

Dishwashers include controllers that execute programs for a wash routine. It is conventional for the wash routines to operate at a wash fluid temperature range from about 135° F. (57° C.) to about 160° F. (72° C.) and, more specifically, at from about 145° F. (62° C.) to about 150° F. (66° C.). A particular problem associated with these wash routines is that they can fail to effectively wash kitchenware and remove/rinse away burned-on food stains. Namely, enzyme based detergents work on starch and protein soils, but the foregoing temperature ranges affect the activity of the enzyme based detergents on burned-on soils. Enzyme based detergent works on proteins and starches because of its chemical nature. Amylases work on starch, and protease works on protein, which are both typically present in enzyme based detergents. Once a food is burned on to kitchenware, the burned-on stain becomes a carbonized soil. More specifically, when a starch/sugar or protein is burned, its chemical structure is changed, thus making the enzymes ineffective against carbonized food soils. Enzyme based detergents have a limited activity time that can range from about a few minutes to about a half of an hour. This activity time is dependent on several factors including, for example, water temperature, water softness, the amount of soil in the wash fluid. Generally speaking, these enzyme based detergents are less effective at higher wash fluid temperatures. An enzyme based detergent could be ineffective on starches and proteins if the wash fluid is not at the correct temperature for enzyme activity.

One conventional method utilized with dishwasher routines is to first treat the stain with enzymatic detergent, and then treat the carbons and proteins with an alkaline detergent. After both detergents release consecutively, heated wash fluid circulates through the wash chamber of the dishwasher to remove the carbons and proteins from the kitchenware.

Another conventional method of removing multiple types of stains off kitchenware is to operate the fluid circulation assembly (i.e., the wash fluid jet) at reduced and variable intensities. A wash fluid pump can work at a lower speed during a pre-wash cycle so that the sprayed wash fluid is less intensive. Instead, the food residue is therefore treated over a longer time and peak occurrences are reduced or flattened. In this manner, the filter is not overloaded with residue, thus preventing back contamination and decreased cleaning effect. The pulsing or variable intensity is achieved by a decreased volume of fluid intake and an increased volume of air into the jet pump, which operates at a lower conveyance capacity to provide the pulse behavior.

Still another method of removing carbonized and protein stains includes the following steps: (1) pre-washing the kitchenware to reduce loose foods; (2) spraying an enzymatic fluid into the wash chamber after the pre-wash cycle to aid in release of stuck-on foods; (3) optimizing humidity maintained in the wash chamber with the aid of a humidity sensor; and (4) returning the routine to normal cycles once a turbidity sensor senses that all soil is washed off the kitchenware.

However, a need still exists for a dishwasher, and likewise a dishwasher cleaning cycle, that effectively washes kitchenware, and more particularly treats and removes burned-on soils and stains. Further, a dishwasher and/or cleaning cycle that provides the improved cleaning without the addition of additional components to the dishwasher is particularly desirable.

### SUMMARY OF THE DISCLOSURE

A first exemplary embodiment of the present disclosure is directed toward a dishwasher including a housing, a wash chamber in the housing that receives kitchenware therein, a detergent dispenser for introducing a detergent into the wash chamber, and a heater for heating the wash fluid circulated in the chamber. The dishwasher further includes a controller for selectively controlling water supply to and from the wash chamber and selectively energizing the heater. The controller establishes a temperature of the wash fluid circulating in the wash chamber during the first period in a first temperature range for example, from about 115° F. (46° C.) to about 135° F. (58° C.), for enhancing the performance of a first detergent, for example, an enzyme-based detergent.

The present disclosure includes a method of washing kitchenware in a dishwasher having a wash chamber. The method includes (i) removing loose soil on the kitchenware in at least one pre-wash cycle, (ii) washing kitchenware in a main wash cycle, and (iii) rinsing the kitchenware in at least one rinse cycle. The main wash cycle comprises the actions of (i) washing the kitchenware in a first temperature range with a first detergent, for example, an enzyme-based detergent, for a first period and (ii) washing the kitchenware in a second temperature range with a second detergent, for example, a chlorine-based detergent, for a second period.

The present disclosure is further directed toward a method of washing kitchenware in a dishwasher. The method includes (i) removing loose soil from kitchenware in a dishwasher chamber by circulating wash fluid in at least one pre-wash cycle; (ii) washing the kitchenware in a main wash cycle; and, (iii) rinsing the soil off the kitchenware. The main wash cycle, in particular, includes time-releasing a first detergent, for example, an enzyme based detergent, in the dishwasher chamber at intervals from about every ten minutes to about every twenty minutes during a first period. The wash fluid is maintained in a first temperature range, for example of from about 115° F. (46° C.) to about 135° F. (58° C.), to enhance the wash performance of the first detergent. For this first period, and over a duration of from about thirty minutes to about forty-five minutes, variable amounts of the first detergent are released into the dishwasher chamber. A second detergent, for example, a chlorine based detergent, is subsequently released into the dishwasher chamber at a conclusion of the first period. The wash fluid temperature is established in a second range, for example, from about 150° F. (65° C.) to about 160° F. (72° C.), to enhance the wash performance of the second detergent, for a second period, which is preferably a duration of from about ten to about twenty minutes.

Another exemplary embodiment of the disclosure is directed toward a dishwasher comprising a wash chamber, a circulation system for spraying wash fluid in the wash chamber, a detergent dispensing system for selectively dispensing at least a first detergent and a second detergent to the interior of the wash chamber, and a heater for heating the wash fluid received in the wash chamber. The dishwasher further includes a controller for controlling the operation of the circulation system, the dispensing system and the energization of the heater. The controller is operative to provide a wash cycle comprising a first period and a second period. The controller is operative in the first period to cause the wash fluid circulation system to spray wash fluid in the wash chamber, to cause the dispenser system to dispense the first detergent into the wash chamber and to control energization of the heater to establish a wash fluid temperature in a first predetermined temperature range conducive to effective use of the first detergent. The controller is further operative in the second period to cause the wash fluid circulation system to circulate wash fluid in the wash chamber, to cause the dispenser system to dispense the second detergent into the wash chamber and to control energization of the heater to establish wash fluid temperature in a second predetermined temperature range conducive to effective use of the second detergent.

A primary benefit of the present disclosure is the ability to address adhered soil.

Another benefit relates to using water temperature control to treat adhered soil wash performance.

Yet another benefit is associated with optimizing enzyme based detergent performance.

Still another benefit stems from bulk detergent dosing to enhance the enzyme based detergent performance.

Further benefits and advantages will become apparent from reading and understanding the following detailed description.

### BRIEF DESCRIPTION OF THE DRAWINGS

FIG. 1 is a partial perspective view of a dishwasher according to an exemplary embodiment of the present disclosure.

FIG. 2 is a schematic representation of a wash routine provided by the dishwasher of FIG. 1.

FIG. 3 is a chart plotting temperature over time for a wash routine including multiple cycles.

FIG. 4 is a block diagram illustrating one embodiment of a control system that can be used with the present dishwasher to activate and monitor the routine of FIGS. 2 and 3.

### DETAILED DESCRIPTION OF THE PREFERRED EMBODIMENTS

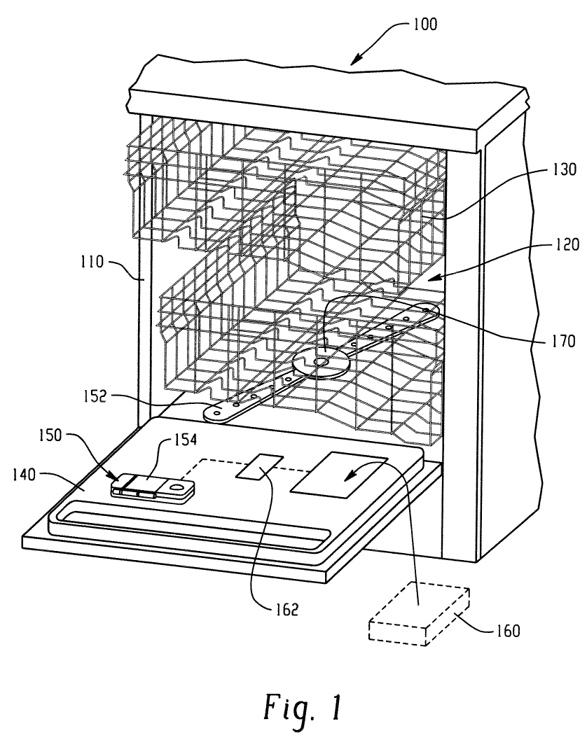

FIG. 1 shows a dishwasher 100 in which the present to-be-described wash routine is incorporated according to an exemplary embodiment of the present disclosure. The dishwasher 100 includes a housing 110 having a dishwasher chamber 120, which contains at least one dish rack 130 for supporting kitchenware (dishes, cutlery, cups, etc.) contained therein. The dishwasher 100 includes a dishwasher door 140 that pivotally opens or closes for loading and unloading of the kitchenware into the chamber; however, the present methods and wash routines disclosed herein can be incorporated in dishwasher embodiments having different configurations, e.g., drawers that extend and retract into the dishwasher chamber.

A detergent cup 150 is strategically positioned within the dishwasher chamber 120 (e.g., on an inner surface of the dishwasher door 140) where wash fluid sprayed from a fluid circulation system 152 comes into direct contact with detergent contained therein. The detergent cup 150 includes a closure member or cap 154 which is opened or actuated to a release position by a command of the controller. In one embodiment, the detergent cup may be a multiple-cup dispenser of the type disclosed in commonly owned application U.S. Ser. No. 12/393,884, filed Feb. 26, 2009. The multiple-cup dispenser includes at least two individual, isolated compartments that prevent intermixing of their respective contents. Corresponding latch covers releasably secure each closure member over a respective compartment. Each compartment is usually assigned to a stage of pre-wash, main wash, and rinse cycles. The compartments automatically time-release detergents during different stages of a wash cycle so that an entire detergent concentration is not dispensed as a single release in one cycle segment. Of course, one skilled in the art will appreciate that other conventional detergent cup arrangements could be alternatively used without departing from the intent of the present disclosure.

The dishwasher 100 can alternatively, or additionally, include a bulk detergent module 160, which receives a large volume of detergent so that an operator or consumer can reduce the number of times the dishwasher must be filled with detergent. Another advantage to this module is the bulk detergent module also allows introduction of variable amounts of detergent during at least one portion of a wash cycle. The amount can be dependent on turbidity sensor readings during individual periods of the wash cycle or can be a more simplified time release. The present disclosure also contemplates a multi-tank dispensing system that is essentially multiple bulk detergent modules having dedicated chambers and pumps of different types of detergents. One of the bulk dispensing systems could be dedicated for introducing a rinse aid. Also, phased bleach and enzyme based detergent doses can be achieved through a combination of detergent cup 150 and one or more bulk dispensing systems.

A controller 162 selectively controls wash fluid supply to and from the wash chamber 100. The controller generates signals to enhance wash performance for enzyme based detergents over a first period and for bleach based detergents over a second period. The controller further commands or controls energization of a heater 170 for establishing the desired temperature for the wash fluid distributed in the wash chamber. The heater is preferably a tubular or sheathed electric resistance heater 170, which is typically situated adjacent a lower surface wall in the wash chamber.

The present disclosure is directed toward wash routines that enhance wash performances for enzyme based detergents, chlorine based detergents, or a combination of releases for both of at least one enzyme based detergent and at least one chlorine based detergent. More specifically, there is a wash routine provided herein that maximizes wash performance regardless of the detergent type filled by a user into the multiple-cup dispenser, the bulk dispenser or the conventional cup dispenser.

Normally, an enzyme based detergent or a bleach based detergent is provided in granule, liquid or gel form. The operator/user enters a desired wash cycle through an interface (e.g., select input pads) into the controller. A wash cycle typically operates at the highest temperature range possible with an expectation that higher temperatures loosen stuck-on food soils and/or sanitize kitchenware. If the consumer filled the dispenser system(s) of the dishwasher with a chlorine based detergent, the higher temperatures combined with the chlorine activity will effectively sanitize dishes; however, the chlorine is not as strong a performer against certain carbohydrates, proteins, or carbonized food soils. An operator may therefore choose to alternately use an enzyme based detergent in the dispenser system to more strongly impact the wash performance. However, the enzyme activity is reduced, or otherwise compromised, at the very high operating temperatures of the wash fluid circulating in the dishwasher.

An enzyme based detergent has a strong impact on carbohydrate and protein based food soil. The food stains that are burned on, however, are transformed to a carbonized soil that is difficult to remove at the higher temperatures. There are several reasons for this difficulty: (1) the enzymes generally quickly become inactive or less active at the higher temperatures; and, (2) the interaction of the enzymes with carbonized soils is weaker versus the carbohydrate or protein type soil stains.

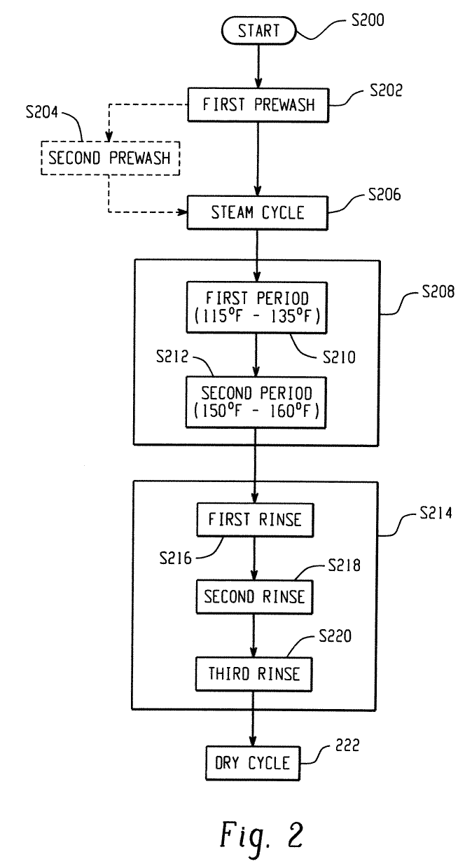

FIG. 2 is a flow chart illustrating an exemplary method for washing kitchenware according to the present disclosure. More specifically, FIG. 2 is a schematic representation of a wash routine provided by the dishwasher disclosed herein. The wash routine starts at step S200. Upon activation of the wash routine by the user, the controller activates at least one pre-wash cycle (step S202), which removes loose soil on kitchenware supported on racks 130 (FIG. 1) contained in the wash chamber. The wash routine can continue with an optional second pre-wash (step S204), in which instance the pressure of wash fluids sprayed from corresponding pumps of the fluid circulation system can be the same, stronger, or weaker than the pressure of the wash fluids sprayed in the first pre-wash cycle S202. Generally loose soil on the kitchenware is removed in the first pre-wash S202 (or even in the optional second pre-wash S204) and the wash fluid carries such soil (not shown) out of the wash chamber through a conventional drainage system.

In some instances there is soil remaining on the kitchenware which was not successfully removed in the at least one pre-wash cycle(s) S202 (S204). It has been determined that the remaining soil is oftentimes carbonized soils. In the illustrative embodiments described herein, the dishwasher routine includes a steam cycle (step S206) subsequent to the pre-wash cycles. The steam cycle S206 softens the remaining, adhered soil by first introducing wash fluid into the wash chamber to wet inner surfaces and kitchenware contained therein. As the heater remains operational, the steam cycle S206 next vaporizes the wash fluid to generate steam in the wash chamber environment by droplets of the wash fluid contacting exposed hot surface portions of the heater. More particularly, details of the steam cycle may be found in commonly owned application Ser. No. XX/XXX,XXX, (Attorney Docket No. 229024/GECZ 200888) filed contemporaneously herewith.

A main wash cycle (step S208) follows a conclusion of either the pre-wash cycles S202-S204 or the optional steam cycle S206 if either cycle is selected or run. The main wash cycle S208 includes a first period (step S210) for washing the kitchenware within a first temperature range for an enzyme based detergent and a second period (step S212) for washing the kitchenware within a second temperature range for a chlorine based detergent.

The first period S210 of the main wash cycle S208 includes circulating a wash fluid in the wash chamber at a temperature that enhances the wash performance of the detergent dispensed for the first period. For the embodiment in which the first detergent is an enzyme-based detergent, satisfactory results have been demonstrated with a wash fluid temperature in the range from about 115° F. (46° C.) to 135° F. (58° C.). In one embodiment, the wash fluid is circulated at a temperature of approximately 125° F. (52° C.). The temperature range is lower than that practiced in conventional main wash cycles and as a result enzyme based detergent remains active longer when compared with the normal temperature ranges (e.g. 135° F./57° C. to 145° F./63° C.) for wash fluid circulating in known systems. Above approximately 135° F. (57° C.), wash performance of typical enzyme-based detergents is not enhanced. However, the method of the subject disclosure is not subject to a lower limit on the temperature. It is envisioned that a development of enzymes that enhance activity in lower temperate ranges, i.e., at temperatures below 115° F. (46° C.), can be utilized in the present dishwasher and in conjunction with the present method. The heater is controlled to maintain desired temperature conditions by means of an electronic control. In the illustrative embodiments, the electronic control uses temperature feedback from a temperature sensor disposed in the sump area of the wash chamber to decide when to open and to close a relay that supplies electrical power to the heater to establish the desired fluid temperature. However, though the unpredictability of the temperature of the water supplied to the dishwasher limits the precision of such an approach, it is recognized that open loop duty cycle control, to approximately establish desired wash fluid temperatures, could be similarly employed.

The first period S210 is preferably of a duration from about 30 to about 45 minutes in an exemplary embodiment. At least one variable amount of enzyme based detergent is released into the wash chamber during the first period S210. One release of a variable amount of the enzyme based detergent can be from about four milliliters (4 ml) to about one hundred milliliters(100 ml) and, more preferably, from about fifteen milliliters (15 ml) to about twenty milliliters (20 ml). It is not entirely necessary that an enzyme based detergent be deposited in the cup, multi-cup dispenser and/or bulk dispenser of the dishwasher model if the operator elects to utilize only chlorine based detergent. However, in an instance where the user does fill such dispenser(s) with an enzyme based detergent, the controller will positively command a release of such detergent during the first period S210 of the main wash cycle S208. The enzyme based detergent can be a liquid, a gel, a tablet or a granular form. The controller is in direct communication with the dispenser containing the enzyme based detergent such that the detergent is released in a desired manner (amount and at preselected times) during the wash cycle, and particularly during the first period S210.

The enzyme based detergent is time-released into the wash chamber at a duration into the first period S210 that enhances an activity of the enzyme based detergent for wash performance. As used herein, “time-released” refers to the timing when the enzyme based detergent is first introduced into the cycle, which is generally accomplished by a release of the closure member 154 (see FIG. 1) or cap of the detergent cup 150 at a predetermined time. In an embodiment including release of multiple, variable amounts of enzyme based detergents, the detergents are time-released into the wash chamber at predetermined intervals. These intervals are dependent upon variables, such as, for example, water softness hardness of the wash fluid, temperature of the wash fluid, etc. As a result, the controller can time-release the detergent in an efficient, effective manner and may employ an algorithm utilizing user inputs which defines the variables. For example, test strips may be supplied to or obtained by the operator to determine water hardness. The user then inputs the value or result of the water hardness test into an interface or input on the dishwasher. The information or data is sent to the controller, which then calculates a desired interval for selectively dispensing detergent based on an algorithm. By way of example only, activity of the enzyme based detergent diminishes relative to the water softness, i.e., the softer the water, the shorter the activity time. Therefore, the intervals between multiple releases are shorter for enzyme based detergent released in cycles circulating wash fluid containing soft water. Of course, the intervals may change based on other parameters such the temperature. For example, a thermistor provided in a sump region of the dishwasher provides a temperature reading of the wash fluid that is indicative of the temperature of the food soil adhered on the kitchenware. Thus, the temperature input to the controller can also be advantageously used to determine a desired interval that maximizes effectiveness of the wash fluid and detergent.

During the first period S210, which is directed toward enzyme based detergent, the wash fluid is at a lower temperature as aforementioned, and is circulating through the wash chamber before a subsequent wash period operating at a higher temperature. The second period S212 of the main wash cycle S208 circulates the wash fluid in the wash chamber at a temperature from about 140° F. (65° C.) to about 160° F. (72° C.) and, more specifically, from about 150° F. (65° C.) to about 160° F. (72° C.). The second period S212 is directed toward maximizing the chlorine activity, and henceforth the wash performance, of chlorine based detergent. The activity of chlorine based detergent can likewise be effected by the variables of temperature, water hardness, etc. Chlorine-based detergents are effective in sanitizing dishes, but are not as effective as enzyme based detergent in removing protein and starch based soils. Again, the controller of the present disclosure does not recognize whether or not the user fills the various one or more dispensers with an enzyme based or chlorine based detergent. Therefore, the second period S212 of the main wash cycle S208 continues to run even in instances where a chlorine based detergent may not be present in the dispenser. However, the present main wash cycle S208 provides a method of insuring that whichever type of detergent is used in the dishwasher, the kitchenware contained in the chamber is subjected to at least one period in which the chamber conditions will most effectively enhance the activity of the wash performance of the detergent on a carbonized, a starch, or a protein based food stain.

In one embodiment, a duration of the second period S212 is from about 20 to about 30 minutes. The main wash cycle S208 concludes with the wash fluid temperature in the higher temperature range of about 150° F. (65° C.) to about 160° F. (72° C.). The main wash cycle is then followed by a rinse cycle (step S214). The rinse cycle includes at least a first rinse (step S216) for rinsing the food soil from the kitchenware. This food soil likely includes the carbonized soils loosened by the enzyme activity in the first period S210 of the main wash S208. This food soil may also contain carbohydrate and protein soils that were not completely removed in the pre-wash cycles S202, S204. The rinse cycle S214 can optionally include a second rinse (step S218) that more specifically rinses the enzyme and/or chlorine based detergents and residue from the kitchenware. The rinse cycle S214 may further include an optional third rinse (step S220), which circulates wash fluid at a temperature from about 140° F. (60° C.) to about 150° F. (65° C.). The wash fluid temperature for the third rinse S220 is in the high range so as to raise the temperature of the wash chamber 120 (FIG. 1) environment so that a subsequent, optional dry cycle is expedited. The dry cycle (step S222) is similar to that of conventional systems, wherein ambient air is drawn into the wash chamber, and the raised temperature of the chamber aids in drying the kitchenware and venting moisture-laden heated air from the chamber.

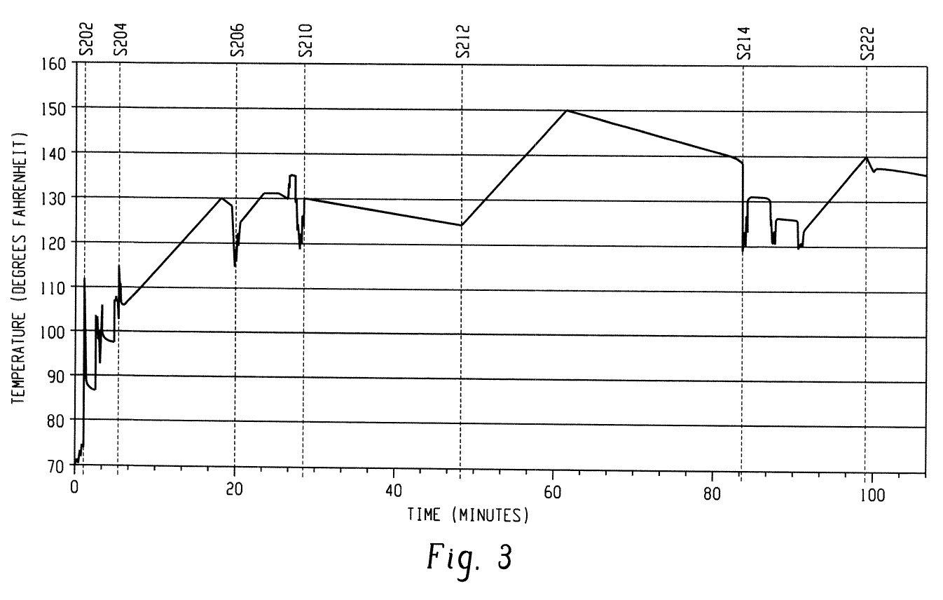

FIG. 3 is a chart plotting temperature relative to time over a run of the wash routine of FIG. 2. The control uses temperature set points during the wash cycles and/or periods to control, i.e., energize and de-energize, the heater at different times and for different durations to maintain the wash temperature in a desired range. In general, 115° F. (46° C.) is a lower set point for the heater to activate energization, and 135° F. (58° C.) is a higher set point for the heater to deactivate and/or de-energize during the first period. For other points in the cycle, the heater is continuously energized until a maximum wash fluid temperature set point is achieved. For example, a maximum temperature set point of 150° F. (66° C.) would cause the heater to de-energize (i.e., shut off) at a desired point during the second period. A set point of 140° F. (60° C.) would cause the heater to de-energize during the final rinse. Similarly, a set point of 130° F. (54° C.) would cause the heater to de-energize during a prewash preceding a steam cycle.

As is shown in the plot, the temperature of wash fluid circulating within the wash chamber during the pre-wash cycle(s) S202, S204 climbs over approximately the first 20 minutes to a temperature preferably between about 115° F. (46° C.) to about 135° F. (58° C.), and more preferably to about 130° F. (55° C.). The plot varies for a short duration, in which the temperature increases to about 85° F. in the first prewash, then the wash fluid is drained and the temperature increases again in a second prewash to approximately 105° F., and the wash fluid is drained a second time. These increases and decreases result from wash fluid sprayed into the wash chamber at predetermined times of the wash routine and then emptied for purposes of prewash segments of the cycle. The heating element during portions of the wash cycle is at least partially exposed during at least a portion of the steam prewash segments of the cycle. The exposed surface is contacted by water and because the heater is at an elevated temperature, the water is turned into steam.

At approximately the thirty minute mark, the first period S210 of the main wash begins. The temperature is maintained during the first period S208 at a lower set point of about 115° F. (46° C.) and a higher set point of about 135° F. (58° C.). Therefore, the plot shows that the heating element is de-energized since the temperature is above 115° F. (46° C.) (shown at approximately the 32-minute mark). The heating element remains de-energized for an entire duration that the temperature of the wash fluid remains above 115° F. (46° C.). This extended first period of washing between 115° F.-135° F. is an ideal temperature range for an enzyme based detergent which is introduced at an early stage of this first period. Multiple doses of the detergent can be introduced over the term of the first period. At approximately the fifty minute mark, the temperature dips to about 125° F. Next, the heating element energizes in response and the main wash cycle shows a temperature increase toward a peak temperature of about 150° F. (66° C.) at about 60-minutes into the wash routine. This increase in temperature is representative of the second period S212 of the main wash, wherein the chlorine detergent works best at the higher temperature. The heating element is directed through the controller to de-energize once a temperature of 150° F. (66° C.) is reached so that there is no heat damage to the kitchenware (i.e., melting, etc.) The subsequent decline in the plot represents a duration in the second period S212 in which the heating element is de-energized, yet the wash fluid (for example, preferably with a chlorine based detergent) is circulated through the wash chamber. The heating element is set to re-energize if the temperature reading falls below 135° F. (58° C.) during the second period S212.

Shortly after the eighty minute mark, the wash fluid circulating in the wash chamber is drained as is evidenced by the immediate decline in the graph plot. The following series of spikes represent first and second rinse cycles (at least one rinse cycle) and draining of wash fluid. The temperature of the wash fluid in the final rinse cycle is then elevated to at least 140° F. (60° C.) so that the temperature in the chamber environment is raised for purposes of aiding in drying the dishes during the dry cycle S222.

Although the wash routine is illustrated and described above in the form of a series of cycles, it will be appreciated that the various methods or routines of the present disclosure are not limited by the illustrated ordering of such cycles. In this regard, except as specifically provided, some cycles may occur in a different order and/or concurrently with other acts or events apart from those illustrated and described. It is further noted that not all of the illustrated cycles may be required to implement a wash routine or a method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated dishwasher 100.

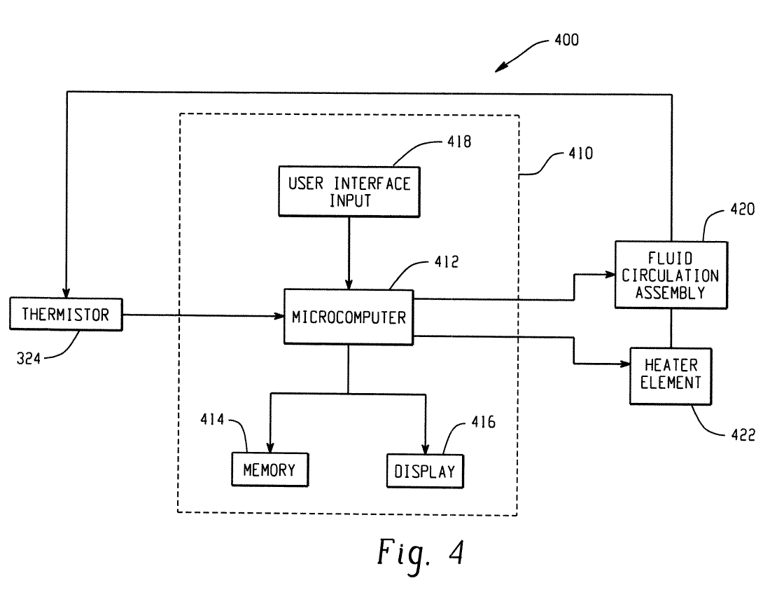

FIG. 4 illustrates one embodiment of a control system 400 that can be used with the present dishwasher to activate and monitor the routine(s) disclosed herein. The control system 400 includes a controller 410 (e.g., a microcomputer 412), which effectively operates various components of the dishwasher. The controller interacts and is operatively associated with a memory 414, a display 416, and a user interface 418. The memory 414 stores instructions, calibrations and constants, data, etc., and other information necessary to complete a various routine. The memory 414 includes a look-up table, for example, which lists dispense intervals for the variable detergent releases of the first period of the main wash based on results of variables input into the user interface 418. The user interface allows an operator to enter instructions, variables, and routine selections for activation of a wash routine. The controller operates components of the dishwasher, such as, the fluid circulation assembly 420, a pump, a heater 422, a wash fluid filter, etc., to deliver wash fluid and rinses to the spray arms or carry/drain wash fluid away from the chamber.

Display 416 indicates an operational stage of the dishwasher or provides other data input/selections or ouput/messages to and from the controller. In addition, a thermistor 424, which is preferably mounted in the sump area of the dishwasher tub in a location which is immersed in wash fluid when a fluid is being circulated so as to be responsive to the temperature of the wash fluid, measures temperature of the wash fluid and communicates this data to the controller. During those cycles such as the dry cycle, during which little or no wash fluid is present in the sump, the sensor would be responsive to the ambient temperature in the wash chamber.

Further, the controller provides the timing signals for the wash cycles, communicates with the dispensers to actuate the dispenser to introduce at least one variable amount of enzyme based detergent and/or the chlorine based detergent during the first and second periods, and is operatively associated with a rinse aid cup (not shown), which dispenses certain rinse aids during the at least one rinse cycle S214.

In the described manner, the present dishwasher and method of washing kitchenware includes a routine that will enhance wash performance of the dishwasher based on at least two periods, each of which circulates wash fluid at a temperature range dedicated toward optimizing the wash performance of a certain type of detergent released in the wash chamber during such period.

The present disclosure provides a wash cycle/algorithm for washing dishes. Overall wash performance is targeted and specifically adhered soils are addressed. Some notable aspects of the cycle are as follows:
One or more prewashes prior to a main wash;
One of the prewashes may utilize a bulk detergent dispenser to add detergent to the wash fluid and to heat the wash fluid to a temperature suitable for increased soil pretreatment ahead of the main wash;
One main wash with the following aspects:
   One period of the main wash that controls the wash fluid temperature to enhance performance of enzyme-based detergent. During this period the bulk dispenser can dispense detergent multiple times at intervals that allow for longer enzyme-based detergent action, since enzymes are only active for a finite time once introduced to the wash fluid given conditions of fluid temperature, fluid hardness, amount of food soils, etc.;
   One period of the main wash where wash fluid temperatures are increased to enhance the performance of alkalinity based detergents;
One or more post rinses for eliminating the detergent and suspended fine particulates in the wash chamber and wash fluid; and,
An optional dry cycle for drying the dishes after washing.

The disclosure has been described with reference to the preferred embodiments. Obviously, modifications and alterations will occur to others upon reading and understanding the preceding detailed description. For example, phased bleach and enzyme doses can be achieved using a bulk dispensing system 160 for enzyme based detergents and a standard main detergent cup 150 for bleach based liquid, powdered detergent, action packs, tablets, etc., where the main cup 150 is opened or actuated after the wash fluid reaches a predetermined temperature (about 135° F.) following the first period. Also, the illustrative embodiments herein described disclose the use of a steam cycle, and other cycles in combination with the main wash cycle, however, it is to be understood that the main wash cycle described herein could be used with or without other cycles such as the steam cycle or other pre-wash cycles. It is intended that the disclosure be construed as including all such modifications and alterations.

1. A dishwasher comprising:
a housing;
a wash chamber in the housing that receives associated kitchenware therein;
at least one detergent dispenser for introducing an associated detergent into the wash chamber;
a heater for raising a temperature of wash fluid circulated in the wash chamber; and,
a controller for selectively controlling water supply to and from the wash chamber and controlling energization of the heater, the controller being operative to control the energization of the heater to establish the temperature of the associated wash fluid circulating in the wash chamber during the first period within a range from about 115° F. to about 135° F.

2. The dishwasher of claim 1, wherein a duration of the first period is from about 30 to about 45 minutes.

3. The dishwasher of claim 1, wherein the controller is operatively associated with the dispenser to actuate the dispenser to introduce at least one variable amount of associated enzyme based detergent into the wash chamber during the first period.

4. The dishwasher of claim 3, wherein the detergent dispenser includes a bulk dispenser for releasing the associated enzyme based detergent during at least the first period.

5. The dishwasher of claim 4, wherein the bulk dispenser time-releases the associated enzyme based detergent into the wash chamber at varying intervals.

6. The dishwasher of claim 4, wherein the bulk dispenser dispenses the enzyme based detergent as a liquid or gel detergent form.

7. The dishwasher of claim 1, wherein the controller is operative to establish a temperature of the associated wash fluid circulating in the wash chamber during the second period in the range from about 150° F. to about 160° F.

8. The dishwasher of claim 7, wherein a duration of the second period is from about 20 to about 30 minutes.

9. The dishwasher of claim 7, wherein the controller is operatively associated with the dispenser to actuate the dispenser to introduce at least one amount of an associated chlorine based detergent into the wash chamber after conclusion of the first period and at initiation of the second period.

10. A method of washing associated kitchenware in a dishwasher having a wash chamber, comprising:
removing loose soil on the associated kitchenware in at least one prewash cycle;
washing the associated kitchenware in a main wash cycle, comprising:
washing the associated kitchenware with wash fluid in a first temperature range for enzyme based detergents for a first period, and
washing the associated kitchenware with wash fluid in a second temperature range for chlorine based detergents for a second period; and,
rinsing the associated kitchenware in at least one rinse cycle.

11. The method of claim 10, wherein the first temperature range is from about 115° F. to about 135° F.

12. The method of claim 10, wherein the first period is a duration of from about 30 to about 45 minutes.

13. The method of claim 10, further comprising releasing at least one variable amount of associated enzyme based detergent into the wash chamber during the first period.

14. The method of claim 10, further comprising time-releasing the associated enzyme based detergent into the wash chamber at predetermined intervals depending upon a softness of the associated wash fluid.

15. The method of claim 10, wherein the second temperature range is from about 150° F. to about 160° F.

16. The method of claim 10, wherein a duration of the second period is from about 20 to about 30 minutes.

17. The method of claim 10, further comprising:
rinsing the food soil from the associated kitchenware in a first rinse,
rinsing detergents and residue from the associated kitchenware in a second rinse, and
circulating associated wash fluid at a temperature from about 140° F. to about 150° F. in a third rinse.

18. The method of claim 10, further comprising heat drying the associated kitchenware in a dry cycle.

19. The method of claim 10, further comprising releasing at least one of the associated enzymes based and chlorine based detergents into the wash chamber during a single wash routine.

20. A method of washing associated kitchenware in a dishwasher, comprising:
removing loose soil from associated kitchenware in a dishwasher chamber by circulating associated wash fluid in at least one pre-wash cycle;
loosening stuck-on soil from the associated kitchenware in a steam cycle;
washing the associated dishes in a main wash cycle, including:
time-releasing at least one amount of enzyme based detergent in the dishwasher chamber at intervals from about every 10 to about every 20 minutes during a first period,
circulating associated wash fluid at a temperature from about 115° F. to about 135° F. for the first period and over duration from about 30 to about 45 minutes,
releasing a chlorine based detergent in the dishwasher chamber at a conclusion of the first period, and
circulating associated wash fluid at a temperature from about 150° F. to about 160° F. for a second period from about 10 to about 20 minutes;
rinsing the soil off of the associated kitchenware.

21. A dishwasher comprising:
a wash chamber;
a circulation system for spraying washing liquid in the wash chamber;
a detergent dispensing system for selectively dispensing at least a first associated detergent and a second associated detergent to the interior of the wash chamber;
a heater for heating the washing liquid received in the wash chamber;
a controller for controlling the operation of the circulation system, the dispensing system and the energization of the heater and operative to provide a wash cycle comprising a first period and a second period;
the controller being operative in the first period to cause the wash fluid circulation system to spray wash fluid in the wash chamber, to cause the dispenser system to dispense the first associated detergent into the wash chamber and to control energization of the heater to establish a wash fluid temperature in a first predetermined temperature range conducive to effective use of the first associated detergent; and
operative in the second period to cause the wash fluid circulation system to circulate wash fluid in the wash chamber, to cause the dispenser system to dispense the second associated detergent into the wash chamber and to control energization of the heater to establish wash fluid temperature in a second predetermined temperature range conducive to effective use of the second associated detergent.

22. The dishwasher of claim 21, wherein a duration of the first period is from about 30 to about 45 minutes.

23. The dishwasher of claim 21, wherein the first associated detergent is an enzyme-based detergent.

24. The dishwasher of claim 21, wherein the second associated detergent is a chlorine-based detergent.

25. The dishwasher of claim 23, wherein the detergent dispenser includes a bulk dispenser for releasing the associated enzyme based detergent as an associated liquid or gel detergent form during at least the first period.

26. The dishwasher of claim 25, wherein the bulk dispenser time-releases the associated enzyme based detergent into the wash chamber at varying intervals.

27. The dishwasher of claim 23, wherein the first temperature range is from about 115° F. to about 135° F.

28. The dishwasher of claim 24, wherein the second temperature range is from about 150° F. to about 160° F.

29. The dishwasher of claim 24, wherein a duration of the second period is from about 20 to about 30 minutes.
